(19) United States
(12) Patent Application Publication
(10) Pub. No.: US 2025/0058656 A1
(43) Pub. Date: Feb. 20, 2025

(54) FLUID LINE ARRANGEMENT FOR A FUEL CELL VEHICLE

(71) Applicant: FORD GLOBAL TECHNOLOGIES, LLC, Dearborn, MI (US)

(72) Inventors: Guenter Hans GROSCH, Vettweiss (DE); Krystian DYLONG, Cologne (DE); Rainer KIEHN, Frechen (DE); Torsten Hans-Jakob SPUERCK, Bergisch Gladbach (DE)

(73) Assignee: FORD GLOBAL TECHNOLOGIES, LLC, Dearborn, MI (US)

(21) Appl. No.: 18/802,405

(22) Filed: Aug. 13, 2024

(30) Foreign Application Priority Data
Aug. 14, 2023 (DE) 102023121677.5

(51) Int. Cl. B60L 50/71; H01M 8/04029; H01M 8/04746

(52) U.S. Cl. CPC B60L 50/71; H01M 8/04029; H01M 8/04768; H01M 2250/20

(57) ABSTRACT

A fuel cell vehicle and associated fluid line arrangement include a main branch, which passes through a fuel cell unit, and a secondary branch that branches off the main branch and includes a flow limiter having a tube element, the internal cross section of which decreases downstream with respect to a flow direction, and a piston element moveable at least partially downstream along a movement path in the tube element counter to a restoring force between an open position and a restricting position. The flow limiter provides a fluid-carrying cross section of passage that is smaller than in the open position formed between the piston element and the tube element to limit mass flow through the secondary branch between a maximum and minimum mass flow.

### CROSS-REFERENCE TO RELATED APPLICATIONS

This application claims foreign priority benefits under 35 U.S.C. § 119 (a)-(d) to DE Application 10 2023 121677.5 filed Aug. 14, 2023, which is hereby incorporated by reference in its entirety.

### TECHNICAL FIELD

The present disclosure relates generally to a fuel cell vehicle fluid line arrangement and flow limiter.

### BACKGROUND

In the case of fuel cell vehicles, there is a known practice of using a compressor to achieve an optimum flow of air through the fuel cell. In some cases, the compressor is also referred to as a “turbocharger”, even though it is not coupled to a turbine. It is possible to divert a small part of the mass flow (i.e. of the air flow from the compressor) from the main flow via a branch line to flow through another component. It is thereby possible, for example, to cool and/or ventilate components. A limited air flow is required for the ventilation of the fuel cell housing, for example. A small proportion of the fresh air is passed through the housing. If the fuel cell is cooled by a liquid coolant, an ion exchange filter is required to keep the coolant free from ions. For this purpose, the ion exchange filter can be arranged in a branch line of the coolant circuit, through which there is a limited mass flow. A limited mass flow of the coolant can also be used for a water/air cooler. In these and other applications, there is a need, on the one hand, to maintain a certain mass flow through the branch line while, on the other hand, not adversely impairing the mass flow through the main line.

Varying speeds of the compressor result in different mass flows through the branch line, and this may be disadvantageous. A throttle valve can be used, but this must be activated and controlled and requires a large amount of installation space. Such a throttle valve may also have a default or reset position, in which it is either completely closed or completely open. However, neither of these would be appropriate since either too much air or no air at all gets through the throttle valve. Comparable challenges may also arise with regard to a branch line within the coolant circuit.

DE 10 2015 006 720 B4 discloses a flow limiter for a compressed gas container. This has a protective tube with a valve opening arranged at a first end for connection to a gas valve and a compressed-gas container opening arranged at the second end, a first valve stop on the valve opening, and a second valve stop on the compressed-gas container opening, a piston, which can be moved within the protective tube from an outflow position, via an open position, to a filling position and is acted upon on both sides by springs, wherein the piston has a first opening, which is open to flow in both positions, a second opening, which is closed in the outflow position, and a third opening, which is closed in the filling position, wherein the second and third openings are open to flow in the open position.

### SUMMARY

It should be noted that the features and measures presented individually in the following description can be combined with one another in any technically feasible manner and indicate further embodiments of the invention. The description additionally characterizes and specifies the one or more embodiments of the claimed subject matter, in particular in conjunction with the figures.

Various embodiments according to the disclosure provide a fluid line arrangement for a fuel cell vehicle. The fuel cell vehicle is a vehicle, e.g. a passenger vehicle or a heavy goods vehicle, which is supplied with energy by a fuel cell stack or unit. In the fuel cell unit, there is an electrochemical conversion of reactants, wherein the electric energy obtained can be used to operate a drive motor and other components or, alternatively, can be stored temporarily in a battery. In particular, one of the reactants can be oxygen, which is taken from the ambient air. The other reactant can be hydrogen, but alternatives such as low molecular-weight alcohols or ammonia are also conceivable. The fluid line arrangement serves to receive and carry a fluid in the operating state. It has at least one line, typically a plurality of lines. However, it may also have other components, e.g. means for delivering the fluid, such as a pump or a compressor. The fluid may be in the liquid or gaseous state.

The fluid line arrangement has a main branch, which passes through a fuel cell unit, and a secondary branch, which branches off from the main branch. The main branch and the secondary branch form parts of the fluid line arrangement. Each of the branches has at least one fluid line. The terms “main branch” and “secondary branch” serve primarily to distinguish them and should not be interpreted as restrictive as regards the dimensions of the branches or the design thereof in other respects. However, the main branch may be designed to carry a larger mass flow than the secondary branch, i.e. it may have a larger cross section, for example. The main branch passes through the fuel cell unit, i.e. it can carry fluid to the fuel cell unit and can carry fluid away from the fuel cell unit in the operating state. The composition of the fluid may change as it passes through the fuel cell unit. The fuel cell unit has at least one fuel cell. As an option, it may also have components which assist or enable the functioning of the actual fuel cell. The secondary branch branches off from the main branch, and, in particular, it may branch off upstream of the fuel cell unit but possibly also downstream thereof. It is possible but not necessary that the secondary branch re-enter the main branch. The secondary branch may pass through an additional component, which may in principle be any component of the fuel cell vehicle. In this case, the secondary branch is designed to carry fluid to the additional component and to carry fluid away from the latter. In this case too, the composition of the fluid may change.

In various embodiments, the secondary branch has a flow limiter, comprising a tube element, the internal cross section of which decreases downstream with respect to a flow direction, and a piston element, which can be moved at least partially downstream along a movement path in the tube element, counter to a restoring force, out of an open position into a restricting position, in which a fluid-carrying cross section of passage that is smaller than in the open position is formed between the piston element and the tube element. The function of the flow limiter consists in ensuring that the mass flow through the secondary branch does not change too much. In particular, the mass flow through the secondary branch should not be too great in order to prevent undersupply to the main branch.

The flow limiter has a tube element configured to receive the fluid and is therefore fluid-tight. It can be attached upstream and/or downstream to a fluid line of the secondary branch, or it may also form part of such a fluid line. The interior of the tube element may be characterized by an internal cross section which is not constant along the tube element but decreases downstream with respect to a flow direction. The flow direction corresponds to the general direction of movement of the fluid in the operating state. In some embodiments, the flow direction may correspond to an axis of symmetry of the tube element. As regards the operating state, the “upstream” direction, i.e. that counter to the flow, and the “downstream” direction, i.e. that with the flow, may furthermore be defined. The internal cross section of the tube element decreases downstream. The decrease may be in stages or continuous. It may be limited to one portion of the tube element, which may be referred to as a tapered portion or restricting portion. The internal cross section may be constant both upstream and downstream of this portion. It would also be conceivable for the internal cross section to increase upstream (or decrease downstream) outside said portion.

Furthermore, the flow limiter has a piston element, which can be moved at least partially downstream along a movement path in the tube element, counter to a restoring force, out of an open position into a restricting position, in which a fluid-carrying cross section of passage that is smaller than in the open position is formed between the piston element and the tube element. The piston element is arranged inside the tube element and can be moved within the latter along a movement path. The movement path is preferably straight but could also be curved, at least in part. The piston element can be moved out of an open position into a restricting position, wherein the movement takes place at least partially downstream. The movement may also take place partially transversely to the flow direction, i.e. there may be a vector component of the movement path which is oriented transversely to the flow direction. Overall, however, the at least partially downstream movement means that the piston element moves into a region in which the internal cross section of the tube element is smaller. As a result, a cross section of passage through which fluid can pass between the tube element and the piston element decreases towards the restricting position. Even in the restricting position, however, there is a cross section of passage (that differs from zero), that is to say that, even in this position, fluid can flow through between the tube element and the piston element. However, the cross section of passage is larger in the open position, more particularly on account of the changing internal cross section of the tube element. The inflowing fluid imposes a downstream force on the piston element, i.e. it is pushed in the direction of the restricting position counter to a restoring force. This restoring force, which can be generated in various ways, ensures that the piston element moves only when there is a sufficient mass flow in the direction of the restricting position and, when the mass flow decreases, moves back in the direction of the open position. The term “piston element” should not be interpreted as restrictive in respect of the shape or design in other respects. It indicates that the piston element is movable within the tube element, like a piston in a cylinder. The piston element could also be designated in some other way, e.g. as a displacement element or restriction element.

Overall, the flow limiter limits or restricts the mass flow through the secondary branch between upper and lower limits. If there is an excessive increase in the mass flow, the piston element is pushed in the direction of the restricting position by the force of the inflowing fluid, the cross section of passage is reduced, and the maximum mass flow is limited. It is thereby possible to prevent too much fluid flowing through the secondary branch and too little fluid flowing through the main branch. However, the mass flow is not entirely interrupted by the flow limiter through the secondary branch and therefore an auxiliary component arranged therein can be continuously supplied.

According to one embodiment, the fluid line arrangement is designed as a coolant circuit, wherein the main branch serves to cool the fuel cell unit. The coolant is preferably a liquid coolant, e.g. water, a water/glycol mixture or the like. The coolant circuit can pass through different components in addition to the fuel cell unit. During this process, some components can also be heated or temperature-controlled, the coolant releasing heat to the component. It will be understood that the coolant circuit may also pass through a heat exchanger or main cooler, at which the coolant can release heat to the surrounding air. In addition, the coolant circuit is normally assigned a pump, which can be operable either by a dedicated motor or can be coupled mechanically to a drive motor of the fuel cell vehicle. The additional component through which the secondary branch passes may be an ion exchange filter, for example. According to another embodiment, the fluid line arrangement is designed as an air line arrangement, wherein the main branch serves to feed air to the fuel cell unit. After passing through the fuel cell unit, the water-enriched air can be discharged via an exhaust. The additional component through which the secondary branch passes may be a housing of the fuel cell unit.

In one embodiment the piston element has at least one recess, which is open outwards towards the tube element, extends at least partially in the flow direction and at least partially defines the cross section of passage. The recess is formed at the periphery of the piston element. It is open outwards and thus towards the tube element. It extends at least partially in the flow direction, wherein its direction of extent may correspond in some region or regions to the flow direction. However, it may also run completely or partially at an angle to the flow direction. In as much as the flow direction is defined as the axial direction, the recess can preferably run at least partially axially and/or radially. If the recess runs partially in the tangential direction, this would result in a tangential deflection of the inflowing fluid, which could lead in certain circumstances to unnecessary frictional losses. However, this is also not excluded in principle. In particular, the piston clement can have a plurality of recesses, which are spaced apart at least in some region or regions. The recesses can be of groove-type, slot-type, or channel-type design. A land or rib can be formed between two recesses. The cross section of passage can be adapted by means of the number, width, and depth of the recesses. As regards assembly, it is conceivable for a tube element to be combined with different piston elements, depending on requirements. For example, the individual recess may be defined by a contour of rounded and/or polygonal cross section.

Alternatively or in addition, the tube element can have at least one recess, which is open inwards towards the piston element, extends at least partially in the flow direction and at least partially defines the cross section of passage. The recess is formed on the inside of the tube element. It is open inwards and thus towards the piston element. It extends at least partially in the flow direction, wherein its direction of extent may correspond in some region or regions to the flow direction. However, it may also run completely or partially at an angle to the flow direction. If the flow direction is defined as the axial direction, the recess can preferably run at least partially axially and/or radially, but a partially tangential course would also be conceivable. The tube element can have a plurality of recesses, which are spaced apart at least in some region or regions. The recesses can be of groove-type, slot-type, or channel-type design. A land or rib can be formed between two recesses. In this embodiment too, the cross-section of passage can be adapted by means of the number, width and depth of the recesses. For example, the individual recess may be defined by a contour of rounded and/or polygonal cross-section.

According to one embodiment, there is no direct contact between the piston element and the tube element in the restricting position. That is to say that they are spaced apart and an encircling gap is formed between them, said gap defining the cross section of passage. Another embodiment includes a piston element in contact with the tube element in the restricting position. In particular, the contact may be in a plurality of mutually spaced regions. The above-mentioned recesses can be arranged between these regions. The contact with the tube element enables the position of the piston element to be better defined, i.e. unwanted movements may possibly be prevented. This, in turn, enables the cross-section of passage and the mass flow resulting therefrom to be defined more accurately.

The tube element may have a guide element, which interacts in a form-fitting manner with the piston element and along which the piston element can be moved in a guided manner between the open position and the restricting position. The guide element engages with a complementary structure of the piston element. For example, a groove into which the guide element engages may be formed on the piston element. Conversely, the guide element itself could have a groove in which the piston element engages. In either case, the guide element together forms a form-fitting joint with the piston element transversely to the movement path. At least in some embodiments, the guide element extends along the movement path and/or defines the movement path by its course. The guide element can be formed integrally with the tube element or, alternatively, can be produced separately and connected to the tube element.

Embodiments may include a piston and guide element with guidance at the periphery, wherein the guide element engages in a groove or the like on the periphery, the groove being formed on the piston element. On the other hand, other embodiments may include a guide clement passed through a through opening that crosses the piston element. The through opening crosses the piston element and is normally surrounded by the material of the piston element. In particular, the through opening may be arranged centrally on the piston element. This has the advantage that the inflowing fluid exerts forces which are distributed uniformly around the through opening. Asymmetrical force distribution could lead to the guide element being tilted in the through opening. The guide element can be of rod-shaped design. Since it is passed through the through opening within the piston element, it is arranged in the interior of the tube element at a distance from the wall of the latter. It can be connected to the wall by at least one holding element.

The restoring force can be generated by the gravitational force of the piston element, for example. In this case, the restricting position may be arranged higher in respect of the vertical defined by gravity than the open position, e.g. may also be vertically above it, or within an incline or upward sloping portion in the flow direction. Alternatively, when the fluid line arrangement carries a liquid, e.g. a coolant, in the operating state, the restoring force may be generated by buoyancy of the piston element if the open position is arranged higher than the restricting position. In certain circumstances, the restoring forces may be too small for reliable return, however. Moreover, there is a limitation as regards the positioning of the flow limiter in this case, and this may likewise be unwanted. One embodiment therefore envisages that the flow limiter has an elastic return or biasing element, which generates the restoring force and pushes the piston clement towards the open position. The return element may also be referred to as a spring element. It can be arranged directly or indirectly between the tube element and the piston element. At the same time, it is not excluded that the spring or biasing element be formed integrally with the piston element or the tube element. That is to say that the piston element (or a tube element) and the spring element could be portions of the same component, wherein the elastic deformability of the spring element could be achieved, for example, by means of a small material thickness.

In one embodiment, the flow limiter has at least one stop element, which limits the movement of the piston element in the restricting position and/or in the open position by form-fitting engagement with the piston clement. The stop element can be formed integrally with the tube element, for example. However, the stop element may also be produced individually in advance and connected to the tube element, e.g. by form-fitting engagement, frictional engagement, and/or material bonding. The stop clement may be stationary relative to the tube element. The stop element forms a stop for the piston element, thereby limiting movement of the piston. That is to say, when the piston element reaches the stop element, form-fitting engagement occurs, and the piston element is stopped. This can relate to the restricting position, i.e. the piston element is stopped when the restricting position is reached. Alternatively or in addition, it may also relate to the open position. The form-fitting engagement between the piston element and the stop element applies at least partially in the direction of the movement path. A single stop element can be provided for both positions, or one stop element can be provided for each position. It is also possible for a stop element to be connected to the abovementioned guide element, or to be formed integrally therewith. For example, a holding element can simultaneously act as a stop element. It would also be conceivable for a return element to act as a stop element, e.g. a spiral spring, which is completely compressed in the restricting position and no longer acts in an elastic way but instead acts as a rigid body disposed between the tube element and the piston element.

Various embodiments include a flow limiter, which can be provided, in particular, for a fluid line arrangement. The flow limiter may include a tube element, the internal cross-section of which decreases downstream with respect to a flow direction, and a piston element, which can be moved at least partially downstream along a movement path in the tube element, counter to a restoring force, out of an open position into a restricting position, in which a fluid-carrying cross section of passage that is smaller than in the open position is formed between the piston element and the tube element.

The terms mentioned have already been explained above with reference to the fluid line arrangement according to the disclosure and are therefore not explained again. Advantageous embodiments of the flow limiter according to the disclosure correspond to those of the fluid line arrangement according to the disclosure.

Further advantageous details and effects are explained in detail below with respect to one or more representative embodiments illustrated in the figures.

### BRIEF DESCRIPTION OF THE DRAWINGS

FIG. 1 is a schematic illustration of components of a fuel cell vehicle having a first fluid line arrangement according to the disclosure;

FIG. 2 is a schematic illustration of components of a fuel cell vehicle having a second fluid line arrangement according to the disclosure;

FIG. 3is a sectional illustration of a first embodiment of a flow limiter according to the disclosure;

FIG. 4 is a section along line IV-IV in FIG. 3;

FIGS. 5A-5C illustrate perspective sectional illustrations of a second embodiment of a flow limiter according to the disclosure in various states;

FIG. 6 is a sectional illustration of a third embodiment of a flow limiter according to the disclosure; and

FIGS. 7-13 illustrate various configurations of a piston element for a flow limiter according to the disclosure.

### DETAILED DESCRIPTION

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

In the different figures, identical parts are provided with the same reference signs and are therefore generally only described once.

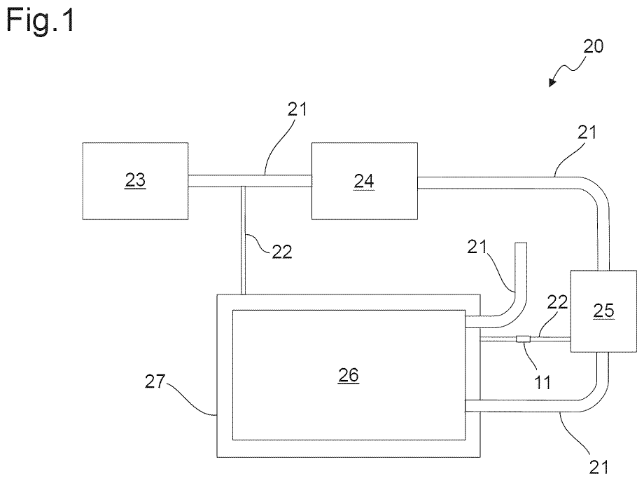

FIG. 1 shows a schematic illustration of parts of a fuel cell vehicle having a first fluid line arrangement 20, which in this case the fluid is air. Fluid line arrangement 20 has a main branch 21, in which an electrically driven compressor 24 generates an air flow. Ambient air is drawn in via an air filter 23. Downstream of the compressor 24, the main branch 21 passes through a water-cooled charge air cooler 25 and then a fuel cell unit 26. Some of the oxygen contained in the air is converted electrochemically with hydrogen in fuel cell unit 26 reducing the oxygen content in the air and increasing the moisture content of the air. The corresponding air flow is discharged to the surroundings. A secondary branch 22 branches off from the main branch 21 at the charge air cooler 25. This secondary branch 22 passes through a housing 27 of the fuel cell unit 26 and then opens into the main branch 21 again upstream of the compressor 24. As it passes through the housing 27, there is a continuous exchange of the air contained therein that reduces accumulation of hydrogen gas.

A flow limiter 1 according to one or more embodiments of the disclosure is arranged upstream of the housing 27, in a region of the secondary branch 22. This flow limiter limits a mass flow of the air within the secondary branch 22 ensuring an adequate air flow through the housing 27 despite variations in the output of the compressor 24 with respect to time, while also preventing undersupply of the fuel cell unit 26 in the main branch 22.

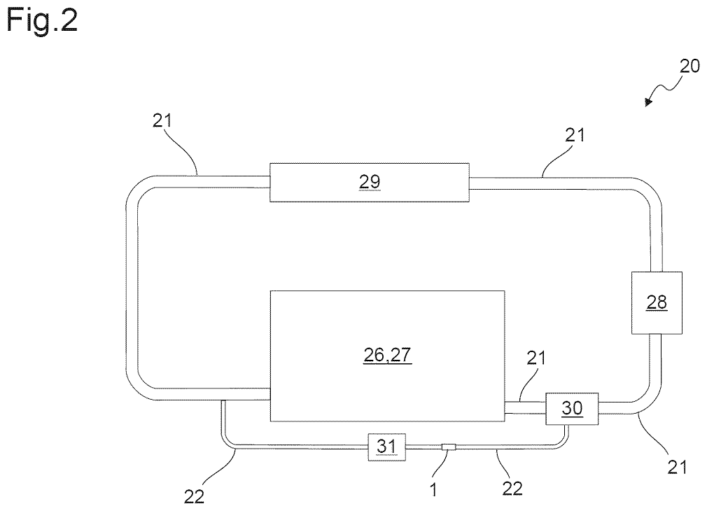

FIG. 2 shows another schematic illustration of parts of a fuel cell vehicle having a second fluid line arrangement 20 according to an embodiment, in this case a coolant circuit. This has a closed-circuit main branch 21, in which an electrically driven pump 28 generates a circulating air flow. In a radiator 29, the coolant is cooled by heat exchange with the ambient air. Downstream of the pump 28, the main branch 21 passes through a particle filter 30 and then a fuel cell unit 26 as well as the housing 27 of the fuel cell unit 26. The main branch 21 then leads back to the radiator 29. A secondary branch 22 branches off from the main branch 21 at the particle filter 30. This secondary branch 22 passes through an ion exchange filter 31 and then re-enters the main branch 21 again upstream of the radiator 29. In this case too, the secondary branch 22 has a flow limiter 1.

Different embodiments of a flow limiter 1 are explained below, it being possible to use these both in the air line arrangement shown and in the coolant circuit shown.

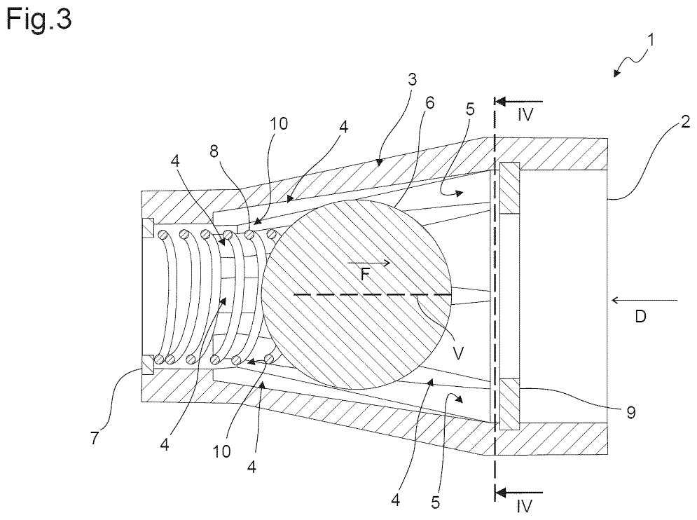

FIG. 3 shows a sectional illustration of a first embodiment of a flow limiter 1. This has a tube element 2, which is connected in a fluid-tight manner to adjoining parts of the secondary branch 21 in the assembled state. It has a restricting portion 3, in which its internal cross section decreases downstream with respect to an intended flow direction D. The general shape of the restricting portion 3 is that of a truncated cone, although a plurality of groove-type recesses 4 is formed on the inside, these extending partially in the flow direction D. Rib portions 5 are formed between the recesses 4. Arranged in the tube element 2, to be more precise in the restricting portion 3 thereof, is a piston element 6, which in the present case is of spherical design with a smooth surface. The piston element 6 can be moved between an open position and a downstream restricting position along a movement path V extending parallel to the flow direction D. Here, the ends of the movement path V indicated in FIG. 3 correspond respectively to the position of the central point of the piston element 6 in the open position and in the restricting position. That is to say that FIG. 3 shows the piston element 6 in an intermediate position.

The partially closing geometry of the piston element 6, which is illustrated as spherical by way of example in FIG. 3, but also in the other figures, may also take some other shape, such as that of a cone, truncated cone, oval or some other shape arranged movably in the tube element 2. The configuration of the piston element 6 can be optimized in terms of flow, thus enabling possible turbulence downstream of the piston element 6 to be reduced.

The piston element 6 is urged in the direction of the open position by a return element 8 (in this case a helical spring), which is supported on the tube element 2 via a supporting element 7. To be more precise, the return element 8 generates a restoring force F, which increases with increasing distance of the piston element 6 from the open position.

To prevent the piston element 6 moving beyond the open position, an annular first stop element 9 is connected to the tube element 2 upstream of the restricting portion 3. In a similar manner, end regions of the rib portions 5 which are situated downstream can act as second stop elements 10, which prevent the piston element 6 moving downstream beyond the intended restricting position.

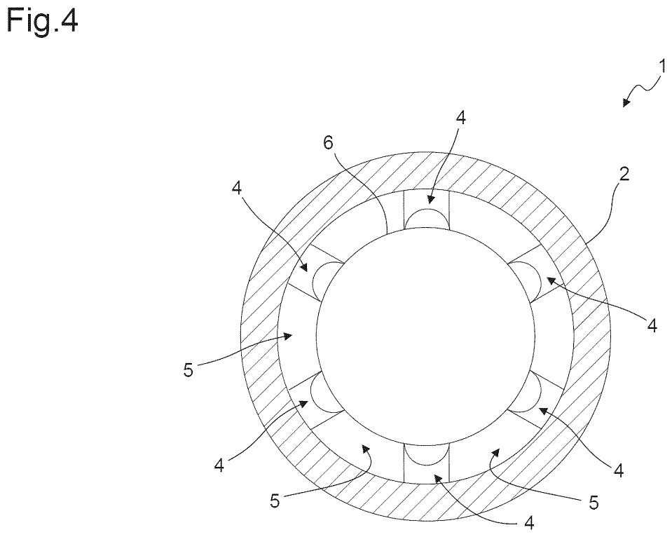

FIG. 4 shows a sectional illustration corresponding to line IV-IV in FIG. 3. Recesses 4 are delimited by an arc-shaped contour. Alternatively, however, this could also be polygonal, e.g. rectangular. It is clearly apparent that even when the piston element 6 is in contact with the rib portions 5 on the outside in the restricting position, there remains a cross section of flow, through which fluid can pass, between the piston element 6 and the tube element 2. When the piston element moves in the direction of the open position, an additional gap opens between it and the rib portions 5, as a result of which the cross section of flow is enlarged. During the operation of the fluid line arrangement 20, there is a flow of fluid from upstream of the piston element 6, giving rise to a force which is opposed to the restoring force F. In general, the corresponding force increases with the mass flow through the auxiliary portion 21 (FIG. 1). On the other hand, the piston element is thereby pushed in the direction of the restricting position counter to the restoring force F, as a result of which the cross section of flow is reduced and the rise in the mass flow is limited.

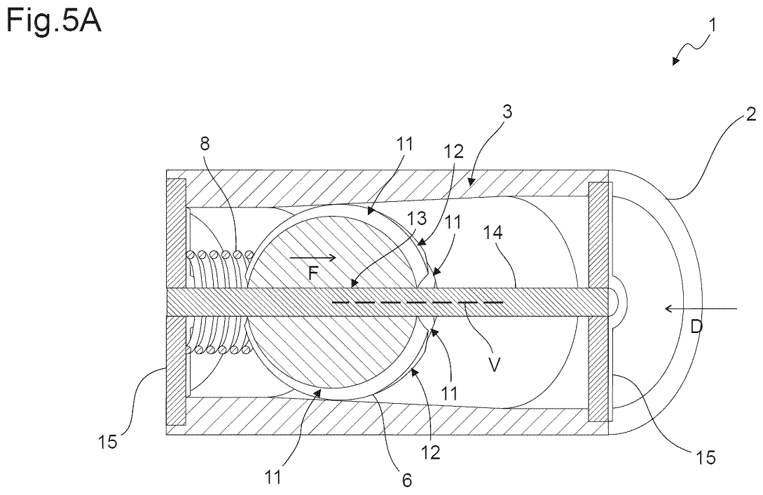

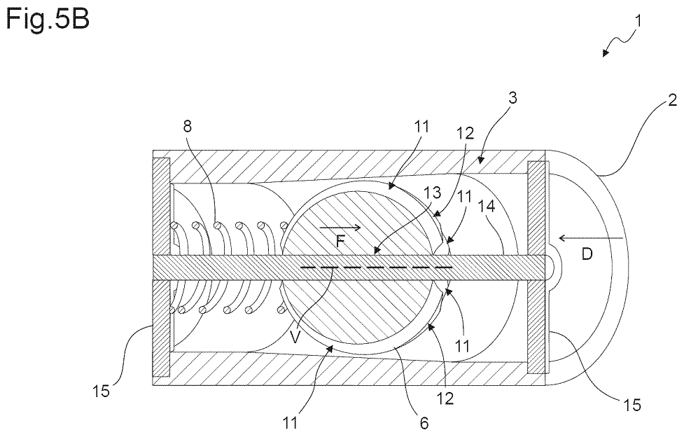

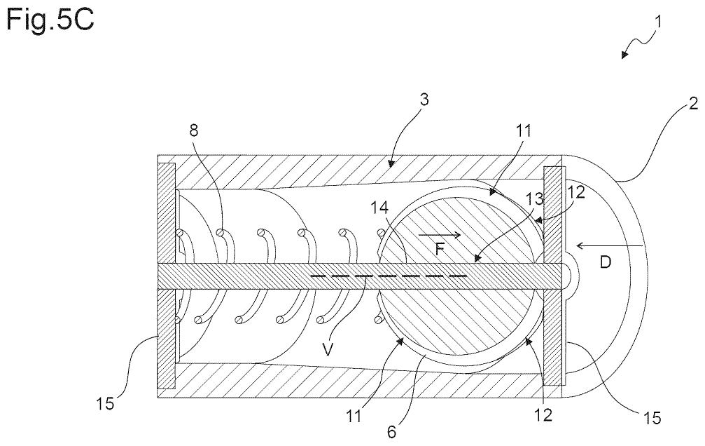

FIGS. 5A-5C show a second embodiment of a flow limiter 1. This is once again a tube element 2 with a tapering restricting portion 3, although said portion is of smooth design in this case. The piston element 6, on the other hand, is not designed as a smooth sphere but has a plurality of recesses 11, which run partially along the flow direction D. Once again, rib portions 12 are formed between these, said rib portions representing parts of a spherical surface. Again, the piston element 6 is acted upon by a return element 8, which is supported via a supporting element 15 on the tube element 2. A guide element 14, which is of cylindrical-rod-shaped design in this example, is secured on this supporting element 15 and on another supporting element 15 connected to the tube clement 2 at an upstream location. Said guide clement is passed through a through opening 13 within the piston clement 6. Thus, by its shape, the guide element 14 defines the course of the movement path V. In this example, the supporting clement 15 that is arranged upstream can also serve as a stop element which defines the open position. FIG. 5A shows the piston element 6 in the restricting position, in which the rib portions 12 are in contact on the outside with the tube clement 2. In this case too, on account of the recesses 11, there is a cross section of flow between the piston element 6 and the tube element 2. FIG. 5B shows an intermediate position, in which the return element 8 has expanded further. The rib portions 12 are no longer in contact with the tube element 2, as a result of which the cross section of flow is increased. This increases to the maximum when the piston element 6 is arranged in the open position, corresponding to FIG. 5C, in which it is retained by the supporting element 15. The guidance by guide clement 14 provides a movement path V and guides the positions of the piston element 6 with high precision.

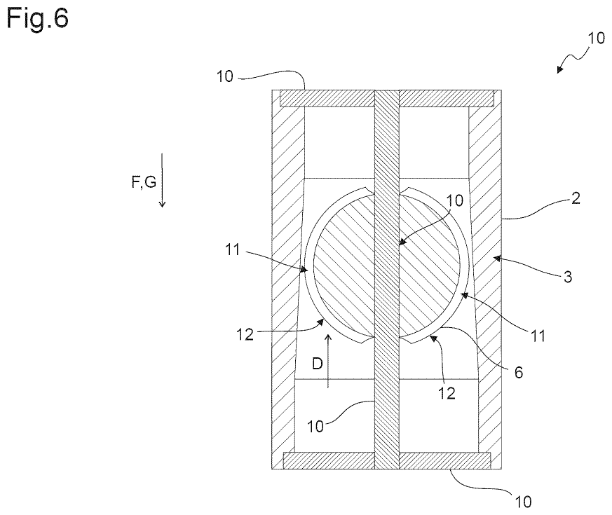

FIG. 6 shows a third embodiment of a flow limiter 1, which is largely identical to the second embodiment and therefore various details will not be explained again. In this case, however, the return element 8 has been omitted and the restoring force F is generated by the gravitational force G acting on the piston element 6. Here, the flow limiter 1 is mounted in such a way that at least a sufficiently large proportion of the gravitational force is directed upstream. In an alternative (not shown here), it would also be conceivable to use a piston element 6 which has a significantly lower density than the fluid, thus enabling the buoyancy to act as a restoring force F. In this case, the flow limiter 1 would be installed in reverse relative to the illustration in FIG. 6.

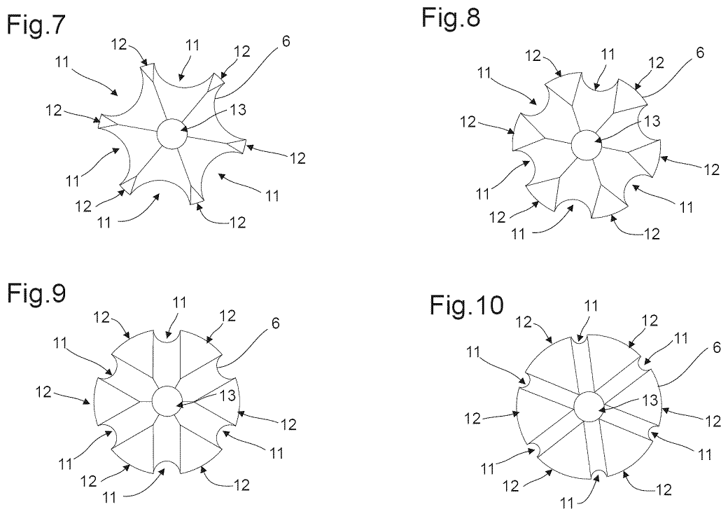

FIGS. 7 to 13 show various embodiments of piston elements 6 that can be used, for example, with the second and third embodiments of the flow limiter 1. In this case, it is also conceivable to combine a tube element 2 with different piston elements 6, as required. FIGS. 7 to 10 each show a piston element 6 with six recesses 11, which are of channel-type design and are delimited by a curved contour. A rib portion 12 is formed between every two recesses 11. The embodiments differ in the size of the individual recesses 11, thereby defining the cross section of passage which remains in the restricting position. The recesses 11 are largest in FIG. 7, while they become increasingly smaller in FIG. 8, FIG. 9 and FIG. 10. FIG. 9 corresponds to the piston element 6 shown in FIGS. 5A-5C and FIG. 6.

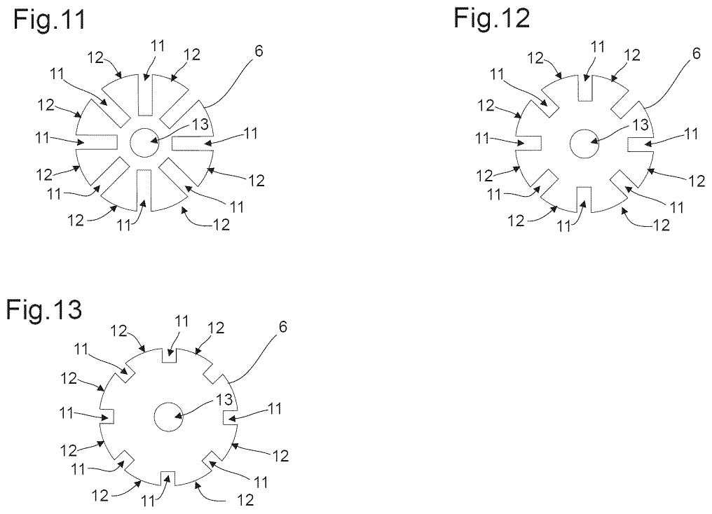

FIGS. 11 to 13 each show a piston element 6 with eight recesses 11, which are cut into the piston element 6 in the manner of slots and are delimited by a polygonal contour. A rib portion 12 is likewise formed between every two recesses 11. The embodiments differ in the size of the individual recesses 11, such as with respect to their depth in the representative embodiments illustrated. By this means too, it is possible to define the cross section of passage which remains in the restricting position. The recesses 11 are deepest in FIG. 11, while they become increasingly shallow in FIG. 12 and FIG. 13.

While exemplary embodiments are described above, it is not intended that these embodiments describe all possible forms of the claimed subject matter. The words used in the specification are words of description rather than limitation, and it is understood that various changes may be made without departing from the spirit and scope of the disclosure. Additionally, the features of various implementing embodiments may be combined to form further embodiments within the scope of the claimed subject matter that are not explicitly described or illustrated.

What is claimed is:

1. A fuel cell vehicle including a fuel cell unit configured to power the fuel cell vehicle, the fuel cell unit coupled to a fluid line arrangement, the fluid line arrangement comprising:
a main branch passing through the fuel cell unit;
a secondary branch branching from the main branch; and
a flow limiter comprising a tube element having an internal cross section that decreases downstream with respect to a fluid flow direction (D), and a piston element moveable at least partially downstream along a movement path (V) in the tube element counter to a restoring force (F) between an open position and a fluid-restricting position, the fluid-restricting position creating a smaller fluid-carrying cross section of passage formed between the piston element and the tube element with the piston element in the fluid-restricting position, relative to the fluid-carrying cross section of passage formed between the tube element and the piston element when the piston element is in the open position.

2. The fuel cell vehicle of claim 1, wherein the fluid line arrangement comprises a liquid coolant circuit and the main branch is configured to cool the fuel cell unit using liquid coolant.

3. The fuel cell vehicle of claim 1, wherein the fluid line arrangement comprises an air line arrangement and the main branch is configured to supply air to the fuel cell unit.

4. The fuel cell vehicle of claim 3, wherein the piston element has at least one recess opening outwards towards the tube element that extends at least partially in the flow direction (D) and at least partially defines the cross section of passage.

5. The fuel cell vehicle of claim 1, wherein the tube element has at least one recess opening inwards towards the piston element that extends at least partially in the flow direction (D) and at least partially defines the cross section of passage.

6. The fuel cell vehicle of claim 5 wherein the piston element is in contact with the tube element when the piston element is in the restricting position.

7. The fuel cell vehicle of claim 5 wherein the tube element has a guide element that engages the piston element, and wherein the piston element moves along the guide element between the open position and the fluid-restricting position.

8. The fuel cell vehicle of claim 7 wherein the guide element passes through a through opening that crosses the piston element.

9. The fuel cell vehicle of claim 1, wherein the flow limiter further comprises an elastic return element that generates the restoring force (F) and biases the piston element towards the open position.

10. The fuel cell vehicle of claim 1 further comprising at least one stop element configured to limit movement of the piston element in the open position by form-fitting engagement with the piston element.

11. The fuel cell vehicle of claim 1 further comprising at least one stop element configured to limit movement of the piston element in the fluid-restricting position by form-fitting engagement with the piston element.

12. The fuel cell vehicle of claim 1, wherein the fluid line arrangement comprises a liquid coolant circuit configured to flow a liquid coolant, and wherein the piston element has a buoyancy within the liquid coolant that generates the restoring force (F).

13. The fuel cell vehicle of claim 12 wherein the tube element of the flow limiter is arranged such that the piston element is vertically lower in the tube element when in the fluid-restricting position than when in the open position.

14. The fuel cell vehicle of claim 13 wherein the tube element of the flow limiter is arranged vertically between the fluid-restricting position and the open position of the piston element.

15. A fuel cell vehicle including a fuel cell stack configured to power the fuel cell vehicle, the fuel cell stack coupled to a compressor by an airflow circuit, the airflow circuit having a main branch passing through the fuel cell stack and a secondary branch coupled to the main branch and bypassing the fuel cell stack, the secondary branch comprising:
a flow limiter comprising:
a tube having an internal cross section that decreases downstream with respect to an airflow direction (D);
a piston moveable along a movement path (V) in the tube between an open position and a fluid-restricting position, the fluid-restricting position creating a smaller fluid-carrying cross section of passage between the piston and the tube relative to the open position; and
a spring connected to the piston and configured to apply a restoring force (F) to the piston biasing the piston toward the open position within the tube.

16. The fuel cell vehicle of claim 15, wherein the piston comprises at least one recess opening outward toward the tube that extends in the airflow direction (D) and at least partially defines the cross section of passage.

17. The fuel cell vehicle of claim 16, wherein the tube has at least one recess opening inward toward the piston and extending in the flow direction (D).
